(19) United States
(12) Patent Application Publication
(10) Pub. No.: US 2009/0217335 A1
(43) Pub. Date: Aug. 27, 2009

(54) APPARATUS AND METHODS FOR NETWORK ACCESS

(76) Inventors: Richard Sai Kit Wong, Hong Kong (HK); Leon Lee On Lai, Hong Kong (HK)

Correspondence Address: Kam Law;Jones Day, Edinburgh Tower, 29th Floor, The Landmark, 15 Queen's Road, Central, Hong Kong, HK

(21) Appl. No.: 12/394,028

(22) Filed: Feb. 26, 2009

Related U.S. Application Data
(60) Provisional application No. 61/031,699, filed on Feb. 27, 2008.

(51) Int. Cl. H04N 7/173; H04B 7/00

(52) U.S. Cl. 725/114; 455/41.2

(57) ABSTRACT

This invention encompasses systems for network access. In particular, this invention encompasses systems comprising a set-top box and a two-way wireless remote control device. Methods of using the systems disclosed herein are also disclosed.

### PRIOR RELATED APPLICATIONS

This application claims the benefit under 35 U.S.C. §119(e) of U.S. Provisional Patent Application No. 61/031,699, filed Feb. 27, 2008, which is incorporated herein by reference in its entirety.

### FIELD OF THE INVENTION

This invention encompasses systems for network access. In particular, this invention encompasses systems comprising, inter alias, a set-top box and a two-way wireless remote control device. Methods of using the systems are also disclosed.

### BACKGROUND OF THE INVENTION

World-Wide Web (“the Web”) and television are two widely used information sources in the world. The Web generally is a collection of formatted hypertext pages located on numerous computers around the world that are connected by the internet. The Web has become an important source for information relating to almost any subject imaginable. Although advances in personal computers and web browser software have made the Web accessible to a large segment of the population, some people are still uncomfortable in using personal computers. Furthermore, many other people prefer to stay away from computers at home after working with computers in their offices for hours. Moreover, for security reasons, using the Web at home may require regularly upgrading of security software, such as anti-virus and anti-spy software, which can be both expensive and problematic.

It is common that some people may wish to search the Web for instant information such as getting contact information of restaurants, shops, offices and the like; looking for entertainments and public events; checking public transportations such as bus routes or maps; and the like. However, they may hesitate to do so with a computer because booting the computer and then searching through the internet generally is time consuming before useful information can be retrieved. In contrast, most people are familiar and comfortable with television in their daily life. Furthermore, a TV set can be started almost as soon as the power switch is pressed. Therefore, there is a need for systems that enable people to retrieve information easily from the internet, particularly the Web, on a display device such as a television set. The present invention provides such systems.

### SUMMARY OF THE INVENTION

Provided herein are systems comprising a two-way wireless remote control device, a set-top box having a remote interface that is capable to receive signals from and transmit signals to the two-way wireless remote control device; a server system; and a graphical user interface residing in the server system. In some embodiments, the set-top box is configured to access the graphical user interface. In further embodiments, the set-top box is configured to communicate with a two-way wireless remote control device.

In some embodiments, the system further comprises a display device. In further embodiments, the display device is a television set, a computer monitor or a combination thereof.

In some embodiments, the graphical user interface is generated by the server system. In other embodiments, the graphical user interface is configured as a home portal having a plurality of application icons or links to another set of application icons. In further embodiments, the at least one of the application icons is independently configured to launch an application. In still further embodiments, the application can be used to access the internet; to send or receive a message; to receive a video, audio or data signal; to secure payment on-line; to set a program to record a TV program; or a combination thereof.

In some embodiments, the two-way wireless remote control device comprises a Bluetooth transmitter, a Bluetooth receiver, a Bluetooth transceiver or a combination thereof. In other embodiments, the two-way wireless remote control device comprises a Wi-Fi transmitter, a Wi-Fi receiver, a Wi-Fi transceiver or a combination thereof. In further embodiments, the two-way wireless remote control device comprises a ZigBee transmitter, a ZigBee receiver, a ZigBee transceiver or a combination thereof.

In some embodiments, the two-way wireless remote control device comprises a keypad having a plurality of keys. In other embodiments, at least one of the keys is independently configured to launch an application.

In some embodiments, the set-top box further coupled to a printer, a telephone, a fax machine, a hard drive, at least one video source or a combination thereof. In other embodiments, the at least one video source comprises a cable source, a satellite source, an antenna, a computer, a DVD player, a VCR player, video camera, digital camera or a combination thereof.

In some embodiments, the server system comprises one or more servers selected from a file server, database server, communications server, backup server, print server, mail server, web server, FTP server, application server, VPN server, DHCP server, DNS server, WINS server, logon server, security server, proxy server or a combination thereof.

### DESCRIPTION OF THE DRAWINGS

FIG. 1 depicts an embodiment of the system disclosed herein. The system 1 comprises a set-top box 40 having a remote interface 41 configured to communicate with a remote control device 60 and to access a server system 80 via the internet 90. The set-top box is connected to a TV set 50 having a display device 70. Optionally, The set-top box is coupled with audio/visual devices 10, internet appliances 20, or a combination thereof.

FIG. 2 illustrates a block diagram of the internal components of an embodiment of the set-top box.

### DEFINITIONS

As used herein, “Bluetooth” refers to an industrial specification for wireless personal area networks (PANs). The Bluetooth specifications are developed and licensed by the Bluetooth Special Interest Group. Generally, Bluetooth provides a way to connect and exchange information between devices such as mobile phones, laptops, PCs, printers, digital cameras, and video game consoles over a secure, globally unlicensed short-range radio frequency.

As used herein, “Wi-Fi” refers to the embedded technology of wireless local area networks (WLAN) based on the IEEE 802.11 standard licensed by the Wi-Fi Alliance. Generally, the branding Wi-Fi-CERTIFIED is tested and certified by the Wi-Fi-Alliance. Wi-Fi includes the generic wireless interface of mobile computing devices, such as laptops in LANs. Some non-limiting common uses of Wi-Fi technology include internet and VoIP phone access, gaming, network connectivity for consumer electronics such as laptops in LANs.

As used herein, “ZigBee” refers to an industrial specification for wireless personal area network (WPAN) based on the IEEE 802.15.4 standard. IEEE 802.15.4 defines a robust radio (PHY) and medium access control (MAC) layer, and ZigBee defines the network, security and application framework for an IEEE 802.15.4-based system. The ZigBee Alliance tests and certifies ZigBee Compliant Platforms. Zigbee technology may be used for low-data rate wireless applications, such as industrial control, embedded sensing, medical data collection, smoke and intruder warning, building automation and home automation.

As used herein, a “server application” refers to an application program that accepts connections in order to service requests by sending back responses. Generally, a server application may run on the same computer as the client application using it, or they may connect through a computer network.

As used herein, a “fax server application” refers to a set of software running on a server computer which is equipped with one or more fax-capable modems attached to telephone lines, or software modem emulators which use T.38 (“Fax over IP”) technology to transmit the signal over an IP network.

As used herein, a “file server application” refers to a computer program that allows different programs, running on other computers, to access the files of that computer

As used herein, a “server operating system” refers to an operating system that is intended, enabled, or better able to run server applications.

As used herein, “radio frequency” (RF) refers to electromagnetic radiation having a wavelength from less than a centimeter to about hundreds of meters. RF signals can be focused in one direction (directional) or they can transmit in all directions (omni-directional). An RF transmitter refers to a device that transmits RF signals. An RF receiver refers to a device that separates out and receives particular transmitted RF signals. An RF transceiver refers to an electronic device that transmits and receives RF signals. Some non-limiting examples of suitable applications include uses in communication networks such as home-automation systems, computer networks, telephone networks, radio networks and television networks.

As used herein, “microwave” refers to electromagnetic radiation having a wavelength from about 1 millimeter to about thirty centimeter. A microwave transmitter refers to a device that transmits microwave signals. A microwave receiver refers to a device that selectively receives microwave signals transmitted by a microwave transmitter. A microwave transceiver refers to a devise capable of transmission and reception of microwave signals. In some embodiments, the microwave signal is at a specific frequency from about 2 GHz to about 94 GHz. In other embodiments, the power output of the microwave transmitter is about 100 milliwatts.

As used herein, “infrared radiation” (IR) refers to electromagnetic radiation having a wavelength from the visible region to about 1 millimeter. An IR transmitter refers to a device that transmits IR signals. An IR receiver refers to a device that receives transmitted IR signals. An infrared transceiver refers to a device that transmits and receives IR signals.

As used herein, a “home automation system” refers to a system for a home wherein the system allows its residents to securely access and control the home from any remote location for comfort, energy savings, security and convenience. Some non-limiting examples of suitable uses of the home automation system include adjusting or controlling the security and surveillance systems, cooling systems, heating systems, lighting, doors and window shutters, conventional ovens, microwave ovens, cookers, TVs, computers, multi-media home entertainment systems, automatic plant watering, pet feeding, automatic scenes for dinners and parties, and the like. The home automation system can be accessed and/or controlled by a remote control or over the telephone or the internet.

As used herein, a “building automation system” refers to a system for a building including homes, wherein the system allows its residents to securely access and control the building from any remote location for comfort, energy savings, security and convenience. Some non-limiting examples of uses include adjusting or controlling the security and surveillance systems, cooling systems, heating systems, lighting, doors and window shutters automatically.

As used herein, a “network card”, “network adapter” or “network interface card” (NIC) refers to a piece of hardware designed to allow electronic devices such as computers to communicate over a computer network. Generally, the NIC can be both an OSI layer 1 (physical layer) and layer 2 (data link layer) device. In some embodiments, the NIC provides physical access to a networking medium and provides a low-level addressing system through the use of MAC addresses. In other embodiments, the NIC allows users to connect to each other either by using cables or wirelessly.

As used herein, a “local area network” or “LAN” refers to a computer network covering a small geographic area, like a home, office, or group of buildings. Generally, a LAN has a higher data transfer rates and smaller geographic range than a wide area networks (WANs). Some non-limiting examples of local area network technology include Ethernet over twisted pair cabling, Bluetooth, Wi-Fi, Zigbee, ATM, ARCNET, Token Ring and the like.

As used herein, a “local area network card” or “LAN card” refers to a piece of hardware designed to allow electronic devices to communicate over a local area network.

As used herein, an “Asynchronous Transfer Mode” or “ATM” refers to a cell relay, packet switching network and data link layer protocol which encodes data traffic into small (53 bytes; 48 bytes of data and 5 bytes of header information) fixed-sized cells. Generally, ATM can provide data link layer services that run over SONET (Synchronous Optical Networking) Layer 1 links.

As used herein, a “graphical user interface” (GUI) refers to a type of user interface which allows people to interact with a computer and computer-controlled devices which employ graphical icons, visual indicators or special graphical elements such as widgets, along with text labels or text navigation to represent the information and actions available to a user. The interactions are generally performed through direct manipulation of the graphical elements.

As used herein, an “application icon” refers to an icon that can be used to launch an application by activating or clicking the icon.

As used herein, an “interactive content” refer to any of various types of information that a user can access on demand, such as applications, web pages and other hypertext-based documents, audio, and video, any of which may originate from the Internet or any other remote source. Some interactive data may be embodied in a conventional hypertext language, such as Hypertext Mark-up Language (HTML).

### DESCRIPTION OF EMBODIMENTS OF THE INVENTION

Disclosed herein are systems comprising a display device; one or more servers; a set-top box coupled to the display device; and a graphical user interface residing in the server system, wherein the set-top box is configured to access the graphical user interface and the set-top box is also configured to communicate with a two-way wireless remote control device.

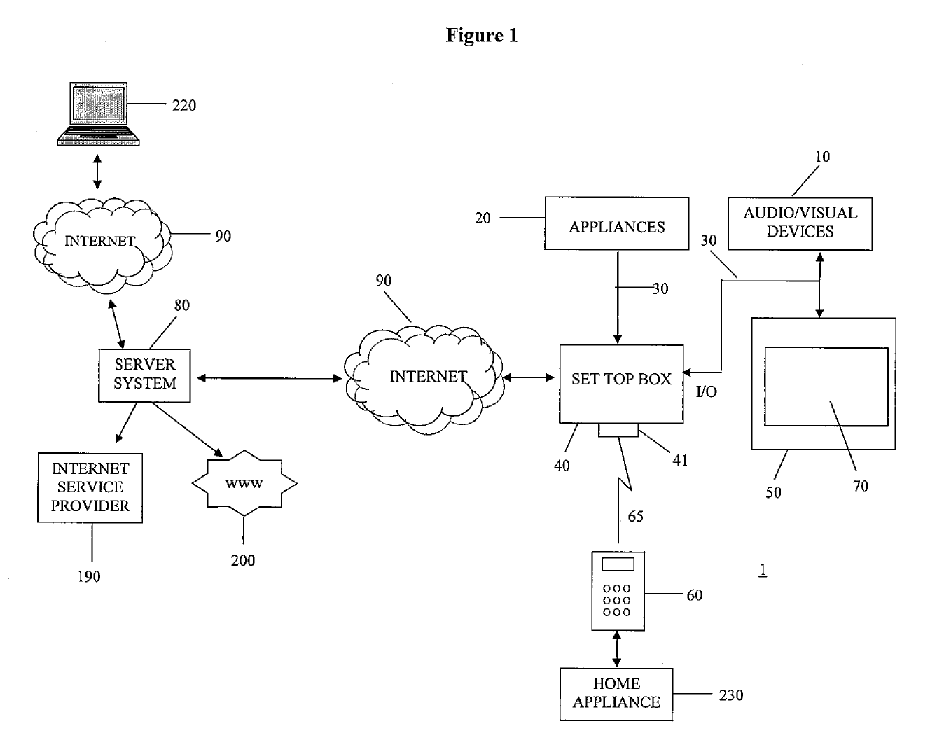

FIG. 1 illustrates an embodiment of the system disclosed herein. The set-top box 40 is connected via a transmission line 30 or wirelessly to a television set 50 having a display device 70. Audio and/or visual signals can be received by the set-top box 40 via the Internet 90 from the server system 80. The set-top box 40 having a remote interface 41 that can receive user inputs entered from a two-way wireless remote control device 60 over a wireless link 65. In some embodiments, the remote interface 41 comprises a transceiver. In other embodiments, the remote interface 41 comprises a combination of a transmitter and a receiver. The wireless link 65 may be a radio frequency (RF) link, or any other suitable type of link. Optionally, the set-top box is further connected via the transmission line 30 or 35 or wirelessly to audio/visual devices 10, internet appliances 20, or a combination thereof. In some embodiments, the set-top box 40 is configured to control the audio/visual devices 10 and/or the internet appliances 20 by user inputs entered from the two-way wireless remote control device 60 or a remote computer (not shown) that communicate with the server system 80.

Optionally, the server system 80 can be connected to the World-Wide Web 200 or one or more internet service providers 190 for accessing information and services therein and/or communicating therewith. In some embodiments, one or more internet service providers 190 provide consumers or businesses access to the Internet and related services. Some non-limiting examples of related services include Internet transit, domain name registration and hosting, web hosting, colocation and combinations thereof. In other embodiments, one or more internet service providers 190 provide web portal service, search engine service, e-mail service, instant messaging service, mob logging service, social networking service, news services (e.g., financial news, sports news, weather information, ), posting service, directory service, map service, sports program service, music and movie content service, gaming service, commerce services (e.g., internet shopping for goods and services such as autos, real estate and travel), advertising service, chat rooms service, message boards service and the like.

In some embodiments, a remote user can access the server system 80 through a desktop computer, laptop computer or handheld computing device via the Internet 90. Generally, a remote control software may be installed in such a host-client system such that the remote user can control the set top box 40 via the server system 80. Furthermore, the remote user can also, through controlling the set top box 40, control the television set 50, audio/visual devices 10, internet appliances 20 and a combination thereof. The remote control software may comprise two separate computer programs, a “host program” that can be installed on the server system 80, and a “client program” that can be installed on the desktop computer, laptop computer or handheld computing device.

In certain embodiments, a user of the system disclosed herein can remotely operate or control the set-top box via the two-way wireless remote control devise. The two-way wireless remote control devise may communicate to the set-top box via two-way signals such as radio frequency (RF) signals, microwave signals and infrared (IR) signals. In some embodiments, the two-way wireless remote control devise is Bluetooth enabled, i.e., it is a Bluetooth remote control devise. In other embodiments, the two-way wireless remote control devise is a Bluetooth enabled mobile phone installed with a software, such as Bluetooth Remote Control from Bluetooth Shareware, that turns the mobile phone into a Bluetooth enabled handheld remote control. In further embodiments, the two-way wireless remote control devise is Wi-Fi enabled, i.e., it is a Wi-Fi remote control devise. In still further embodiments, the two-way wireless remote control devise is Zigbee enabled, i.e., it is a Zigbee remote control devise. In still further embodiments, the two-way wireless remote control devise is handheld.

In certain embodiments, the two-way wireless remote control devise comprises a keypad having a plurality of keys or buttons wherein one or more of the keys are independently configured to launch an application or an activity. In other embodiments, the two-way wireless remote control devise comprises a touchscreen with an icon menu having a plurality of icons. In further embodiments, each of the icon is configured to launch an application, an activity or a sub-menu comprising one or more other icons. In some embodiments, the two-way wireless remote control devise comprises a touchscreen with an icon menu and a keypad having a plurality of keys or buttons. In further embodiments, one or more of the icons or keys are independently configured to launch an application or an activity. In still further embodiments, the touchscreen comprises a display device such as LCD screen.

In some embodiments, the remote control 60 is designed to be user friendly so that any user can learn to control the system disclosed herein with a minimal effort or time. For example, to access the system, a user can simply press the “power on” button in the remote control and optionally type in a password using the keypad of the remote control 60. Further, to facilitate such easy to use features, the keys or buttons of the remote control 60 can be color coded for easy recognition. For example, alphanumeric buttons are in yellow, the Internet button is in green. The design is targeted for users to finish his/her task in the shortest period of time. can perform all necessary functions.

In some embodiments, the remote control 60 comprises “Hot keys” which can be labeled as H1, H2, H3, etc. Such hot keys can be configured to allow users to “bookmark” application. A web page can be provided to the users for configuring the hot keys. The web page can allow different users to configure the hot keys to perform different tasks for their personal needs and preferences. For example, a user may set a hot key (e.g., H1) to get access to the user's favorite newspaper web site, while another user can set the same hot key to get access to the another user's favorite radio station.

In certain embodiments, the remote control 60 comprises application keys which can be labeled as A1-A9, and the like. This customization feature can allow users to configure the applications in the Home Portal's main page. In further embodiments, A1 to A6 cannot be configured. In still further embodiments, only A7 to A9 can be configured. In still further embodiments, three additional application keys, such as A10-A12, can also be added if they are needed. The Web page for configuring the hot keys mentioned above can be also used configuring the application keys according to their personal needs and preferences. For example, a user can set an application key for recording a TV program even though the user is not at home.

In some embodiments, the remote control 60 comprises a “MSG” button which may be used by remote users to communicate with family members at home. The MSG button can be used as an instant access mail box. Further, a Web interface can be provided to remote users to upload pictures, texts, voice or a combination thereof.

In certain embodiments, the remote control 60 comprises an internet button, such as an “I” key, for getting access to the Internet. In other embodiments, the remote control 60 comprises a text button, such as an “T” key, for the users to enter the URL of a website.

In some embodiments, the remote control 60 comprises a barcode reader or barcode scanner. Any electronic device that can read printed barcodes can be used as the barcode reader or barcode scanner disclosed herein. In some embodiments, the barcode reader comprises a light source, a lens and a photo conductor translating optical signals into electrical signals. The barcode reader may contain a decoder circuitry for analyzing the barcode's image data provided by the photo conductor. The remote control 60 can transmit the barcode content to the set top box for displace or for uploading to the server system 80 where the information will be further processed and/or utilized by e-shopping providers.

The remote control 60 can be used as a “link” or “media” between the set top box and the appliances 20. Some non-limiting examples of the appliances 20 include microwave ovens, conventional ovens, washing machines, home theaters, multi-media centers, televisions, display devices, Hi-Fi's, computers, personal music players, radios, CD players and the like. In some embodiments, the two-way wireless remote control devise controls a home-automation system and each component in the home-automation system, such as home theaters, lights, cooling systems, heating systems, doors, curtains, and home appliances. In other embodiments, the remote control can be

The system disclosed herein can be used to turn on an appliance by the following steps: (a) accessing an administrative website provided by the system disclosed herein; (b) logging in the website to control the set-top box; (c) using the set-top box to control the two-way wireless remote control; and (d) using the two-way wireless remote control to control the appliance. In some embodiments, the two-way wireless remote control is placed close to the appliance so that the signals are properly received and transmitted by the appliance and the remote control. In other embodiments, the signals comprise IrDA commands from an IrDA command library. In further embodiments, the IrDA commands are based in the system disclosed herein and therefore, learning by the users is generally not required.

The two-way wireless remote control device disclosed herein may comprise, inter alia, a transmitter, a receiver, a transceiver or a combination thereof. In some embodiments, the two-way wireless remote control device comprises a transmitter and a receiver. In other embodiment, the remote control device comprises a transceiver.

Any transmitter that transmits signals can be used for the two-way wireless remote control device disclosed herein. Generally, a transmitter may comprise a power supply, an oscillator, a modulator and signal amplifier. In some embodiments, the transmitter transmits RF signals. In certain embodiments, the transmitter transmits microwave signals. In other embodiments, the transmitter transmits IR signals. Some non-limiting examples of suitable transmitters include RF transmitters, microwave transmitters and IR transmitters.

Any receiver that receives signals can be used for the two-way wireless remote control device disclosed herein. In some embodiments, the receiver receives encoded radiated transmission from a transmitter, decodes the coded data, and delivers the decoded data signal to an output stage. Some non-limiting examples of suitable output signals include audio, text, graphical and raw digital data signals. Some non-limiting examples of suitable receivers include RF receivers, microwave receivers and IR receivers.

Any transceiver that transmits and receives signals can be used for the two-way wireless remote control device disclosed herein. In some embodiments, the transceiver receives and demodulates a signal from a transmitter or a second transceiver, and then modulates and transmits a new signal to a receiver, the second transceiver or a third transceiver. Some non-limiting examples of suitable transceivers include RF receivers, microwave receivers and IR receivers.

In certain embodiments, the transmission signal can be analogue or digital. Generally, an analogue signal is a nominally continuous electrical signal that varies in amplitude or frequency in response to changes in the stimuli. On the contrary, a digital signal is generally an electronic signal transmitted as binary code that can be either the presence or absence of current, high and low voltages or short pulses at a particular frequency.

In some embodiments, the remote control device can be electrically connected to the set up box via a transmission line or via a wireless communication mechanism. Wireless normally refers to any type of electrical or electronic operation which is accomplished without the use of a “hard wired” connection. Wireless communications refers to the transfer of information over a distance without the use of electrical conductors or “wires”. In certain embodiments, any electromagnetic radiation, such as RF, IR or microwave, may be used to carry wireless signals over part or the entire communication path.

In some embodiments, the set-top box disclosed herein receives signals from the one or more servers and turns the signals into content then displayed on the display device. The set-top box can be digital or analog. The set-top box of the system can be configured to access the graphical user interface generated by the set-top box itself or by the server system. Furthermore, the set-top box is also configured to communicate with the two-way wireless remote control device. In some embodiments, the set-top box comprises a remote interface that sends and receives signals to and from the two-way wireless remote control device via the wireless connection.

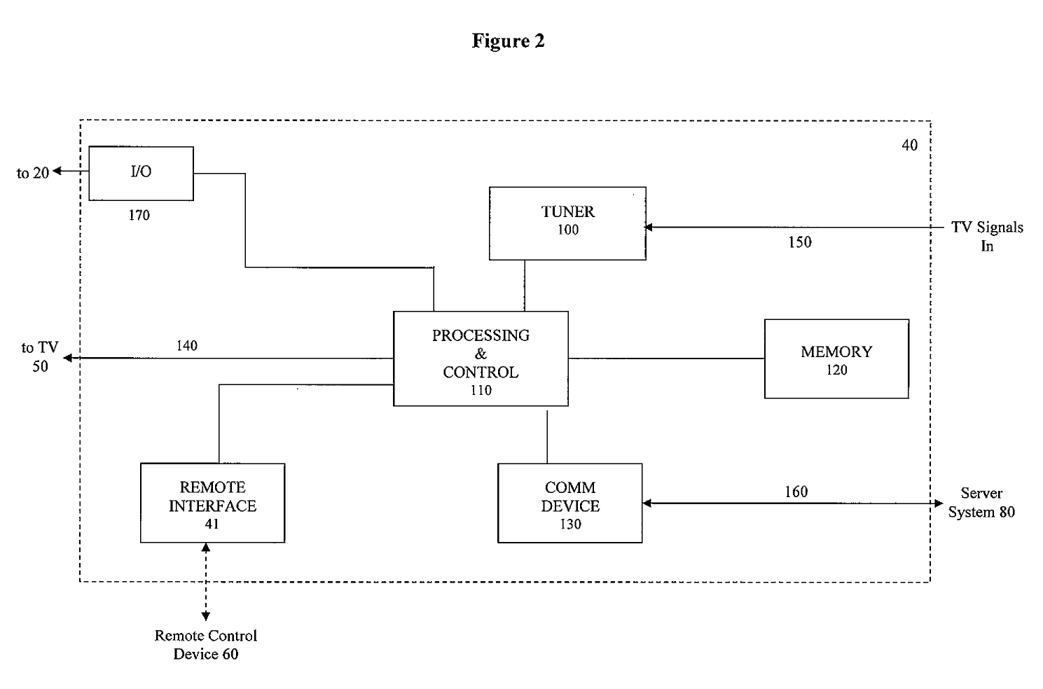

FIG. 2 illustrates a block diagram of the internal components of an embodiment of the set-top box. Each component is optional and may not be necessary for the invention disclosed herein. Referring to FIG. 2, the set-top box 40 optionally includes a processing and control circuitry 110, which can control the overall operation of the set-top box 40. In some embodiments, the processing and control circuitry 110 provides audio and video output to the television set 50 via line 140.

In certain embodiments, the set-top box disclosed herein can be obtained by modifying commercially available devices such as TV set-top boxes, IPTV set-top boxes, desktop computers, laptop computers, handheld computers, or some most advanced video game consoles such as Microsoft's Xbox 360, Nintendo's Wii, and Sony's PlayStation 3. The modification can be done by simply installing a suitable software or program in the device.

In some embodiments, the processing and control circuitry 110 includes one or more of devices selected from general-purpose microprocessors, digital signal processors (DSPs), application specific integrated circuits (ASICs), various types of signal conditioning circuitry, including analog-to-digital converters, digital-to-analog converters, input/output buffers, and the like. In other embodiments, the processing and control circuitry 110 does not comprise an operation system. In further embodiments, the processing and control circuitry 110 does not comprise a general-purpose microprocessor.

Optionally, a remote interface 41 is coupled to the processing and control circuitry 110. The remote interface 41 can wirelessly receive signals from and/or transmit signals to the two-way wireless remote control device 60, a home-automation system (not shown) or one or more components in the home-automation system. The signals can be IR signals, microwave signals and RF signals including Bluetooth signals, Wi-Fi signals and Zigbee signals. In some embodiments, the remote interface 41 is Bluetooth enabled. In other embodiments, the remote interface 41 is Wi-Fi enabled. In other embodiments, the remote interface 41 is Zigbee enabled.

Optionally, a television tuner 100 is coupled to the processing and control circuitry 110. The television tuner 100 receives television signals, such as analog TV, digital TV or IPTV signals, on transmission line 150, which, may originate from an antenna, a DSL modem, a cable modem or the like.

Optionally, a memory 120 is coupled to the processing and control circuitry 110. The memory 120 may include one or more physical memory devices, which may include volatile storage devices, non-volatile storage devices, or both. In some embodiments, the memory 120 may include both random access memory (RAM), read-only memory (ROM), various forms of programmable and/or erasable ROM (e.g., PROM, EPOM, EEPROM, etc.), flash memory, or any combination of these devices.

Optionally, a communication device 130 is coupled to the processing and control circuitry 110. The communication device 130 can be used to transfer data between the set-top box 40 and server system 80 via a data path 160 or the internet. In some embodiments, the communication device 130 may be a LAN card, an Integrated Services Digital Network (ISDN) adapter, a Digital Subscriber Line (XDSL) adapter, a cable television modem, a conventional telephone (POTS) modem, or any other suitable data communication device.

In certain embodiments, various other internal or external components may be added to the set-top box 40. Some non-limiting examples of suitable internal components include graphics processors, USB adaptors, IEEE 1394 adaptors, S-video adaptors, RS-232 adaptors, ethernet adaptors, video decorders, audio decorders, and data decorders. Some non-limiting examples of suitable external components include mouses, pointers, keyboards, mass storage devices, smart card readers, speakers, and printers. Such internal or external components may be connected via a physical connection or by a wireless connection (e.g., a wireless mouse or keyboard). In other embodiments, the internal or external components comprise an I/O interface such as DVI and HDMI terminal.

In some embodiments, software instructions are executed by the processing and control circuitry 110 (e.g., a microprocessor or a DSP). In further embodiments, the software instructions are stored in a memory, such as memory 120. In still further embodiments, the software instructions are loaded into the set-top box 40 from the server system 80 over the data path 160. In further embodiments, the downloaded software instructions are directly execution by the set-top box 40 upon their being received to generate an output. In still further embodiments, the downloaded software instructions are executable indirectly to generate an output by the set-top box 40 using an interpreter, which interprets the instructions, or by otherwise executing instructions which convert the received instructions to instructions that can be directly executed. In some embodiments, the output is a graphical user interface (GUI) comprising a plurality of interactive contents. In other embodiments, the set-top box includes a web browser software that allows the user to access and download interactive contents generated in the server system.

In other embodiments, the set-top box 40 comprises no operating system and the software instructions are executed by the server system and the output is uploaded or transferred to the set-top box 40 over the data path 160. In some embodiments, the output is a graphical user interface (GUI) which can be displayed on the display device as a home portal having a plurality of application icons or links to another set of application icons.

Any computer system that is designated for running one or more specific server applications can be used as a server. In some embodiments, the server system disclosed herein comprises one or more servers. In other embodiments, the server system disclosed herein comprises one server. In certain embodiments, the server system disclosed herein comprises two or more servers. In further embodiments, each of the two or more servers independently run a server application, which may be the same as or different from applications running in the other servers.

Generally, a computer system is designated for only one server application and may be named for that application. Some non-limiting examples of such servers include file server, database server, communications server, backup server, print server, mail server, web server, FTP server, application server, VPN server, DHCP server, DNS server, WINS server, logon server, security server, domain controller, backup domain controller, proxy server, firewall, etc. In other embodiments, server applications can be divided among two or more servers. In further embodiments, every and all server applications can be run concurrently on a single server. In certain embodiments, multiple servers may be required for each application under heavy loading.

In some embodiments, the server system disclosed herein comprises a web server running a computer program that is responsible for accepting HTTP requests from clients, which are known as web browsers, and serving them HTTP responses along with optional data contents, which usually are web pages such as HTML documents and linked objects such as images and the like.

In other embodiments, the server system disclosed herein comprises an application server that delivers applications to client computers or devices. Generally, an application server handles most, if not all, of the business logic and data access of the application (a.k.a. centralization). The term application server applies to all platforms including the Sun Microsystems J2EE platform and servers of web-based applications, such as integrated platforms for e-commerce, content management systems, affiliate management systems, and simple web-site builders.

In certain embodiments, the server system disclosed herein comprises a communications server that operates as a carrier-grade common platform for a wide range of communications applications. In certain embodiments, the communications server may base on industry-managed standards such as AdvancedTCA®, MicroTCA™, Carrier Grade Linux and Service Availability™ Forum.

In some embodiments, the server system disclosed herein comprises a database server dedicated to running a database program. A database program refers to a program that provides database services to other computer programs or computers. Some database management systems (DBMS's) may provide database server functionality, and some DBMS's (e.g., MySQL) may rely on the client-server model for database access.

In other embodiments, the server system disclosed herein comprises a proxy server which services the requests of its clients by making requests to other servers. A client connected to the proxy server, may request a file, connection, web page, or other resource available from a different server. In some embodiments, the proxy server may provide the resource by connecting to a specified server. In further embodiments, the proxy server may alter the client's request or the specified server's response. In certain embodiments, a proxy server may service the request without contacting the specified server. In other embodiments, a proxy server can be placed in the user's local computer or at specific key points between the user and the destination servers or the internet.

In certain embodiments, the server system disclosed herein comprises a gateway server that passes all requests and replies unmodified.

In some embodiments, the server system disclosed herein comprises a fax server that run a fax server application. The fax server may accept documents from users, convert them into faxes, and transmit them, as well as to receive fax calls and either store the incoming documents or pass them on to users. In certain embodiments, fax server users may communicate with the fax server in several ways including through either a local network or the Internet.

In other embodiments, the server system disclosed herein comprises a file server on which a user can map or mount a disk drive or directory so that the directory appears to be on the user's computer at which the user is sitting. In certain embodiments, the user can read or write a file as though it were part of the file system of the user's computer. In certain embodiments, files and directories on the file server can be accessed using a particular protocol, such as WebDAV, SMB, CIFS, NFS, Appletalk or their mutations.

In certain embodiments, the server system disclosed herein comprises a game server used by game clients. Generally, a video game played over the internet requires a connection to a game server.

In some embodiments, the server system disclosed herein comprises a client-server which separates a client from a server. The client-server architecture is generally implemented over a computer network. Each client or server connected to the network may be referred to as a node. In certain embodiments, the client-server architecture employs only two types of nodes: clients and servers. This type of client-server architecture may be referred to as two-tier. Each client software can send data requests to one or more connected servers which can accept these requests, process them, and return the requested information to the client. In certain embodiments, the client software include a web browser.

In certain embodiments, various other internal or external components may be added to the server system. Some non-limiting examples of suitable internal components include a graphics processors, USB adaptors, IEEE 1394 adaptors, S-video adaptors, RS-232 adaptors, ethernet adaptors, video decorders, audio decorders, and data decorders. Some non-limiting examples of suitable external components include mouses, pointers, keyboards, mass storage devices, smart card readers, speakers, and printers. Such internal or external components may be connected via a physical connection or by a wireless connection (e.g., a wireless mouse or keyboard).

In some embodiments, software instructions are executed by the server system and the output is uploaded or transferred to the set-top box and then displayed on the display device. In some embodiments, the output is a graphical user interface (GUI) by which a user can easily access applications, television programs, interactive contents, audio and video sources from the home entertaining center, and combinations thereof. In some embodiments, the graphical user interface is generated by and resides in the server system which can subsequently be upload to, downloaded by or transferred to the set-top box.

In certain embodiments, the graphical user interface is configured as a home portal having a plurality of application icons or links to another set of application icons. Optionally, the home portal may comprise tickers showing important information such as breaking news, stock quotes, daily reminders and the like. In some embodiments, the home portal comprises from 1 to 36 application icons or links. In further embodiments, the home portal comprises 4, 9, or 16 application icons or links.

In some embodiments, the home portal disclosed herein provide web portal service, search engine service, e-mail service, instant messaging service, mob logging service, social networking service, news services (e.g., financial news, sports news, weather information, ), posting service, directory service, map service, sports program service, music and movie content service, gaming service, commerce services (e.g., internet shopping for goods and services such as autos, real estate and travel), advertising service, chat rooms service, message boards service and the like.

In certain embodiments, the execution of software instructions occurs within the server system and the output may be loaded into the set-top box as graphical user interfaces which appears on the display device.

In some embodiments, the GUI can be presented to the user on the display device. The user generally interacts with the GUI by entering inputs from the remote control device. The remote control device can comprise a keypad having a plurality of keys. In certain embodiments, one or more of the keys can be configured independently to launch one or more applications. In some embodiments, one or more of the keys can be configured independently to launch one or more links to web pages or interactive contents such as video streaming and securing payment for e-commerce. In other embodiments, one or more of the keys are preconfigured and cannot be changed by the user. In further embodiments, the user can configure the keys to launch applications and links to web pages or interactive contents. In still further embodiments, the user can use the web pages to configure the keys and applications. In still further embodiments, the keys can be colored-coded for easy recognition.

In certain embodiments, user inputs for launching an application or accessing interactive content can be entered via the remote control device. The signals can be received by the set-top box which is subsequently loaded to and processed by the server system which, in response, load the outputs back to the set-top box and displayed on the display device.

In some embodiments, the software instructions are written in the Hypertext Markup Language (HTML). In certain embodiments, the software instructions are written in the Java programming languages including Personal Java and JavaScript, developed by Sun Microsystems, Inc, Palo Alto, Calif. In other embodiments, the software instructions are written in the C++ programming language. In further embodiments, the software instructions are written in other languages that may be substituted within the scope of the present invention.

The system disclosed herein may comprise any display device that provides a visual presentation of images and texts that are acquired, stored, or transmitted in various forms. In some embodiments, the display device may further provide audio outputs. The display device may be a display component of a TV set, a computer monitor, a projector or a combination thereof.

The display device suitable for the system disclosed herein may be in any format or technology known to a skilled artisan. Some non-limiting examples of suitable display devices or technologies include CRT displays, digital light processing (DLP) displays, plasma display panels (PDPs), liquid crystal displays (LCDs), such as thin film transistor (TFT-LCD) displays and HPA-LCD displays, light-emitting diode (LED) displays, organic light-emitting diode (OLED) displays, electroluminescent displays (ELDs), surface-conduction electron-emitter displays (SEDs), field emission displays (FEDs), liquid crystal on silicon (LCOS or LCOS) displays, interferometric modulator displays (IMODs), laser TVs, electronic papers, and rear projection displays that may be CRT-based, LCD-based, DLP-based, and LCOS-based. One or more of the above-mentioned display device may be use as the display component in television sets or projectors (TVs), such as standard-definition television (SDTVs), enhanced-definition televisions (EDTVs) and high-definition televisions (HDTVs), computer monitors, laptop computers, portable DVD players or a combination thereof.

In some embodiments, the display device is or comprises a cathode ray tube (CRT) display. Generally, the CRT display comprises an evacuated glass envelope containing an electron gun (a source of electrons) and a fluorescent screen. When electrons from the electron gun strike the fluorescent screen, light is emitted from the screen. The electrons may be deflected and modulated in a way which causes them to display an image on the screen. Internal or external means may be used to accelerate and deflect the electrons. Any CRT display known to a skilled artisan can be used for the system disclosed herein.

In certain embodiments, the display device is or comprises a digital light processing (DLP) display. The DLP generally comprises a video projector wherein the image is created by microscopically small mirrors laid out in a matrix on a semiconductor chip, known as a Digital Micromirror Device (DMD). Each mirror represents one pixel in the projected image. These mirrors can be repositioned rapidly to reflect light either through the lens or on to a heatsink (“light dump”). The rapid repositioning of the mirrors can allow the DMD to vary the intensity of the light being reflected out through the lens. Any DLP display known to a skilled artisan can be used for the system disclosed herein. In some embodiments, the DLP display is a single-chip DLP projector. In other embodiments, the DLP display is a three-chip DLP projector. In further embodiments, the DLP display comprise a DLP chipset from Texas Instruments of Dallas, Tex., or from Fraunhofer Institute of Dresden, Germany.

In some embodiments, the display device is or comprises a plasma display panel (PDP). The PDP generally comprises many tiny cells located between two panels of glass hold an inert mixture of noble gases (neon and xenon). The gas in the cells is electrically turned into a plasma which then excites phosphors to emit light. Any PDP known to a skilled artisan can be used for the system disclosed herein.

In certain embodiments, the display device is or comprises a liquid crystal display (LCD). The LCD generally comprises a thin, flat display device made up of a plurality of color or monochrome pixels arrayed in front of a light source or reflector. It generally uses very small amounts of electric power, and is therefore suitable for use in battery-powered electronic devices. Any LCD known to a skilled artisan can be used for the system disclosed herein.

In other embodiments, the display device is or comprises a light-emitting diode (LED) display or panel. The LED display generally comprises a plurality of LED's, each of which independently emits incoherent narrow-spectrum light when electrically biased in the forward direction of the p-n junction. Generally, there are two types of LED panels: conventional, using discrete LEDs, and surface mounted device (SMD) panels. A cluster of red, green, and blue diodes is driven together to form a full-color pixel, usually square in shape. Any LED display known to a skilled artisan can be used for the system disclosed herein.

In certain embodiments, the display device is or comprises an organic light-emitting diode (OLED) display. The OLED display generally comprises a plurality of organic light-emitting diodes. An organic light-emitting diode (OLED) refers to any light-emitting diode (LED) having an emissive electroluminescent layer comprises a film of organic compounds. The electroluminescent layer generally contains a polymer substance that allows suitable organic compounds to be deposited in rows and columns onto a flat carrier to form a matrix of pixels. The matrix of pixels can emit light of different colors. Any OLED display known to a skilled artisan can be used for the system disclosed herein.

In some embodiments, the display device is or comprises an electroluminescent display (ELD). Electroluminescence (EL) is an optical and electrical phenomenon where a material emits light in response to an electric current passed through it, or to a strong electric field. The ELD generally is created by sandwiching a layer of electroluminescent material such as GaAs between two layers of conductors. When current flows, the electroluminescent material emits radiation in the form of visible light. Any ELD known to a skilled artisan can be used for the system disclosed herein.

In other embodiments, the display device is or comprises a surface-conduction electron-emitter display (SED). The SED generally comprises a flat panel display technology that uses surface conduction electron emitters for every individual display pixel. The surface conduction emitter emits electrons that excite a phosphor coating on the display panel. Any SED known to a skilled artisan can be used for the system disclosed herein. In some embodiments, the SED comprises a surface conduction electron emitter from Canon, Tokyo, Japan.

In certain embodiments, the display device is or comprises a field emission display (FED). The FED generally uses a large array of electron emitters comprising fine metal tips or carbon nanotubes, with many positioned behind each phosphor dot in a phosphor coating, to emit electrons through a process known as field emission. The electrons bombard the phosphor coatings to provide visual images. Any FED known to a skilled artisan can be used for the system disclosed herein.

In some embodiments, the display device is or comprises a liquid crystal on silicon (LCOS or LCoS) display. The LCOS display generally is a reflective technology similar to DLP projectors, except that the former uses liquid crystals instead of individual mirrors used in the latter. The liquid crystals may be applied directly to the surface of a silicon chip coated with an aluminized layer, with some type of passivation layer, which is highly reflective. Any LCOS display known to a skilled artisan can be used for the system disclosed herein. In some embodiments, the LCOS display comprises a SXRD chipset from Sony, Tokyo, Japan. In some embodiments, the LCOS display comprises one or more LCOS chips.

In other embodiments, the display device is or comprises a laser TV. The laser TV generally is a video display technology using laser optoelectronics. Optoelectronics refers to the study and application of electronic devices that interact with light wherein light includes invisible forms of radiation such as gamma rays, X-rays, ultraviolet and infrared. Any laser TV known to a skilled artisan can be used for the system disclosed herein.

In certain embodiments, the display device is or comprises an interferometric modulator display (IMOD). Generally, the IMOD uses microscopic mechanical structures that reflect light in such a way that specific wavelengths interfere with each other to create vivid colors, like those of a butterfly's wings. This can produce pure, bright colors using very little power. Any IMOD known to a skilled artisan can be used for the system disclosed herein.

In some embodiments, the display device is or comprises an electronic paper, e-paper or electronic ink. The electronic paper generally is designed to mimic the appearance of regular ink on paper. Unlike a conventional flat panel display, which uses a backlight to illuminate its pixels, electronic paper generally reflects light like ordinary paper and is capable of holding text and images indefinitely without drawing electricity, while allowing the image to be changed later. Unlike traditional displays, electronic paper may be crumpled or bent like traditional paper. Any electronic paper known to a skilled artisan can be used for the system disclosed herein.

As demonstrated above, embodiments of the invention provide various systems for network access. While the invention has been described with respect to a limited number of embodiments, the specific features of one embodiment should not be attributed to other embodiments of the invention. No single embodiment is representative of all aspects of the invention. Variations and modifications from the described embodiments exist. The appended claims intend to cover all such variations and modifications as falling within the scope of the invention.

All publications and patent applications mentioned in this specification are herein incorporated by reference to the same extent as if each individual publication or patent application was specifically and individually indicated to be incorporated by reference. Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the appended claims.

What is claimed is:

1. A system comprising:
a) a two-way wireless remote control device;
b) a set-top box having a remote interface that is capable to receive signals from and transmit signals to the two-way wireless remote control device;
c) a server system; and
d) a graphical user interface residing in the server system,
wherein the set-top box is configured to access the graphical user interface and to communicate with the two-way wireless remote control device.

2. The system of claim 1 further comprising a display device.

3. The system of claim 2, wherein the display device is a television set, a computer monitor or a combination thereof.

4. The system of claim 1, wherein the graphical user interface is generated by the server system.

5. The system of claim 1, wherein the graphical user interface is configured as a home portal having a plurality of application icons or links to another set of application icons.

6. The system of claim 5, wherein at least one of the application icons is independently configured to launch an application.

7. The system of claim 6, wherein the application is used to access the internet, to send or receive a message, to receive a video, audio or data signal, to secure payment on-line, to set a program to record a TV program, or a combination thereof.

8. The system of claim 1, wherein the two-way wireless remote control device comprises a Bluetooth transmitter, a Bluetooth receiver, a Bluetooth transceiver or a combination thereof.

9. The system of claim 1, wherein the two-way wireless remote control device comprises a Wi-Fi transmitter, a Wi-Fi receiver, a Wi-Fi transceiver or a combination thereof.

10. The system of claim 1, wherein the two-way wireless remote control device comprises a ZigBee transmitter, a ZigBee receiver, a ZigBee transceiver or a combination thereof.

11. The system of claim 1, wherein the two-way wireless remote control device comprises a keypad having a plurality of keys.

12. The system of claim 11, wherein at least one of the keys is independently configured to launch an application.

13. The system of claim 1, wherein the set-top box further coupled to a printer, a telephone, a fax machine, a hard drive, at least one video source or a combination thereof.

14. The system of claim 13, wherein the at least one video source comprises a cable source, a satellite source, an antenna, a computer, a DVD player, a VCR player, video camera, digital camera or a combination thereof.

15. The system of claim 1, wherein the server system comprises a file server, database server, communications server, backup server, print server, mail server, web server, FTP server, application server, VPN server, DHCP server, DNS server, WINS server, logon server, security server, proxy server or a combination thereof.
